(19) United States
(12) Patent Application Publication
(10) Pub. No.: US 2006/0288209 A1
(43) Pub. Date: Dec. 21, 2006

(54) Method and apparatus for secure inter-processor communications

(76) Inventor: Dean H. Vogler, Algonquin, IL (US)

Correspondence Address: MOTOROLA, INC., 1303 EAST ALGONQUIN ROAD, IL01/3RD, SCHAUMBURG, IL, 60196, US

(21) Appl. No.: 11/156,412

(22) Filed: Jun. 20, 2005

(51) Int. Cl. H04L 9/00

(52) U.S. Cl. 713/168

(57) ABSTRACT

A portable electronic device (110) is capable of secure inter-processor communications (160) between processors (120, 130). The processors have unique and unalterable device identifiers used to encrypt session key data using shared secrets. A first processor device identifier is encrypted by a first processor (120) and decrypted by a second processor (130) and compared against a known device identifier to verify authenticity. Then the second processor (130) likewise encrypts and the first processor (120) likewise decrypts and likewise compares device identity to verify authenticity.

### BACKGROUND OF THE INVENTIONS

1. Technical Field

The present inventions relate to secure communications and, more particularly, relate to secure inter-processor communications.

2. Description of the Related Art

There are many cellular radio telephones whose architectures now include dual processors. In a typical cellular phone architecture, a baseband or modem processor handles radio telephony tasks; while an application processor handles user interface and personal digital assistance (PDA) like tasks, and other 3^{rd} party vendor applications. Frequent communication and data passes between these processors. The link between them can be referred to as the inter-processor communication (IPC) link.

Security is a growing concern for many kinds of products, especially those that communicate with other devices or networks. Implementing strong security generally requires hardware support. Typical features of baseband and application processors are that they are trusted and secure processors. That is, they are architected and provisioned in such a way that they boot & run in a secure manner. For example, some security elements in secure processors may include a tamper-proof unique identifier and secret key storage capability. When used independently, a security-based processor allows for the design of a trusted device, where the processor forms the root core of trust, and uses its abilities to allow for all critical software on the device to be verified and trusted.

However, one area of concern in a dual-processor architecture, with respect to security, is the inter-processor communication (IPC) link. Since inter-processor messages are passed over this link, which in turn cause each processor to respond and behave in a certain manner, there is some risk that an adversary or hacker can exploit this link. Often times, the physical link between the processors is an easy-to-monitor serial port. Although the baseband and application processors may be individually trusted, the overall device “trustedness” depends on both processors authenticating each other and protecting the information on the inter-processor communication link.

The inter-processor communication link may be a vulnerable point for exploiting security. Messages between such processors have been sent openly and without authentication. A hacker could take advantage of this weakness by injecting messages directly on the link, or perhaps by replacing a processor.

### BRIEF DESCRIPTION OF THE DRAWINGS

FIG. 1 illustrates a schematic block diagram of a portable electronic device according to the present inventions;

FIG. 2 illustrates a flow diagram of provisioning the processors according to the present inventions; and

FIG. 3 illustrates a flow diagram of secure inter-processor communications according to the present inventions.

### DETAILED DESCRIPTION OF THE PREFERRED EMBODIMENTS

The proposed inventions describe how two processors establish a secure inter-processor communication link with mutual authentication. The value of this is to prevent unauthorized messages from being passed from one processor to another. Only authorized processors that have been setup for a secure inter-processor communication link will process messages from each other. The processors must be provisioned with appropriate security measures before they can establish a secure inter-processor communication link. Some important goals in protecting the inter-processor communication link are that it should not impact performance, should not be difficult to provision, should not require large infrastructure support, and should not introduce noticeable overhead to the device (e.g., code size). This is because the processor communication link must be kept “lean and mean” as it is a critical communications path for the device. As a result of these requirements, a public key protocol such as SSL is unsuitable in this environment.

A goal of the embodiments of the present inventions described herein is to establish the inter-processor communication link as a secure inter-processor communication link. A secure inter-processor communication link is one where the two processors have authenticated each other (i.e., each processor is convinced they are talking to the processor they are supposed to be talking to) and are using encryption to protect the data on the link. In other secure communication channels (e.g. SSL, IPsec, WTLS), this is known as a secure authenticated channel (SAC). However, a protocol such as SSL is too large and unwieldy to implement for this use case. For example, a secure authenticated channel with two-way authentication requires that each processor be provisioned with its own public/private key pair. Generally, a manufacturer would not provision multiple processors with their own public/private key pair. Doing so would also take considerable overhead to establish such a PKI (public key infrastructure). Since the challenge is to minimize overhead and reduce performance issues, a different method, one that can meet overhead and performance criteria, is highly desirable.

The embodiments of the present inventions take advantage of known conditions about secure processors and their architecture. At a minimum, it is assumed that each processor can have a unique identifier (UID) that is tamper proof, and has a secret key. The secret key must not be available (i.e., readable) to unauthorized users.

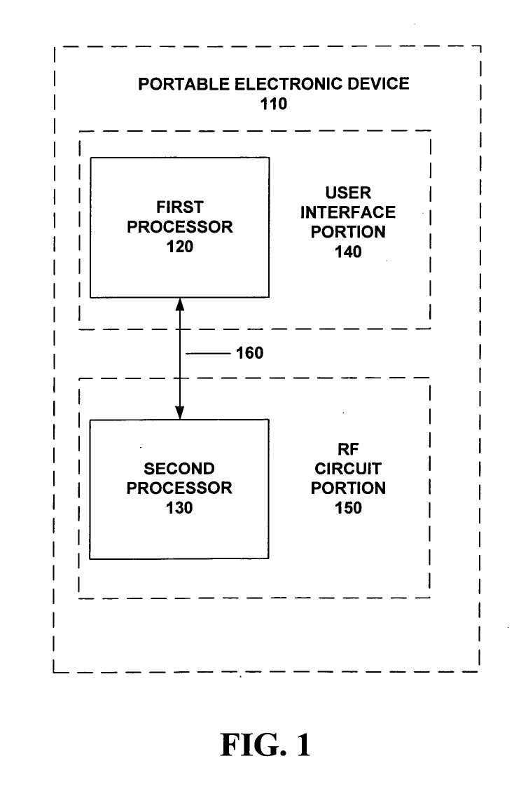

FIG. 1 illustrates a schematic block diagram of a portable electronic device 110 according to some embodiments of the present inventions. The portable electronic device 110 is a cellular radio telephone in a preferred embodiment. The portable electronic device 110 has a user interface portion 140 and a radio circuit portion 150. In a cellular telephone, the radio portion 150 contains RF (radio frequency) circuitry. The user interface portion 140 has a first processor 120, among other functions, operates on inputs from a cellular radio telephone keypad and drives a display. The first processor 120 also may be used to drive an audio speaker and a microphone interface. The second processor 130 controls the radio functions of the portable electronic device 110.

The first and second processors 120 and 130 also enable communications on a communication bus 160 between the user interface portion 140 and the radio portion 150 of the portable electronic device 110. Communications need to be trusted over the communication bus 160 between these portions 140 and 150.

The portable electronic device platform, which employs more than one processor, becomes trusted when the communications link between trusted processors is itself secured for privacy and authentication. The present inventions allows the communication link over the communication bus 160 to be secured for privacy and authentication using a low overhead method. It is desired to choose a low overhead method that that does not rely on public key or PKI technology, in order to improve performance and reduce code size. This also greatly simplifies factory provisioning and the system infrastructure to support it.

Before a secure inter-processor communication link can be established, each pair of processors must be provisioned with a shared secret and the unique identifiers of both processors. The shared secret is for privacy, so that the data across the channel remains encrypted during the secure inter-processor communication link setup. The unique identifiers are for authentication, providing evidence for each processor during authentication. Provisioning is done only once and ideally in a secure area of a factory process. Provisioning requires that the shared secret be transmitted as plaintext to both processors. Once this is accomplished, the shared secret and the unique identifier of the each processor will be encrypted using the processor's secret key, and all accesses to the encrypted information will be restricted. Thus, access to the information that is encrypted will be restricted to only authorized processes such as, for example, some kind of boot process that is trusted for instance by way of a secure boot-up. If a processor has already been provisioned with a shared secret, any future provisioning sequence attempt should be disallowed by the processor. As an additional optional step, the processors may have a counter value (stored encrypted with the processor's secret key), initially set to zero (0), to thwart replay attacks.

The provisioning is a protocol for secure inter-processor communication link establishment that begins with a first processor randomly generating a session key. The session key and the first processor's unique identifier, along with the optional counter value incremented by one, are encrypted using the first processor's shared secret and sent to the second processor. The second processor recovers the session key, unique identifier, and optional counter, using the first processor's shared secret, and optionally checks that the first processor's counter value is one greater than its own counter value. It authenticates the first processor by checking that the unique identity received is the one that was stored during provisioning. In return, the second processor encrypts its unique identity (and optionally its counter value incremented by one) with the session key, to prove to the first processor that it has succeeded in establishing the session key and to present its own unique identification or “credentials.” The first processor authenticates that the received unique identifier is the same one that was stored during provisioning and optionally checks that the second processor counter value is the same as its processor counter value. The first processor responds with an acknowledgement. At this point the inter-processor communication link is now available for use as a secure authenticated link and the session key will be used to encrypt messages between the two processors.

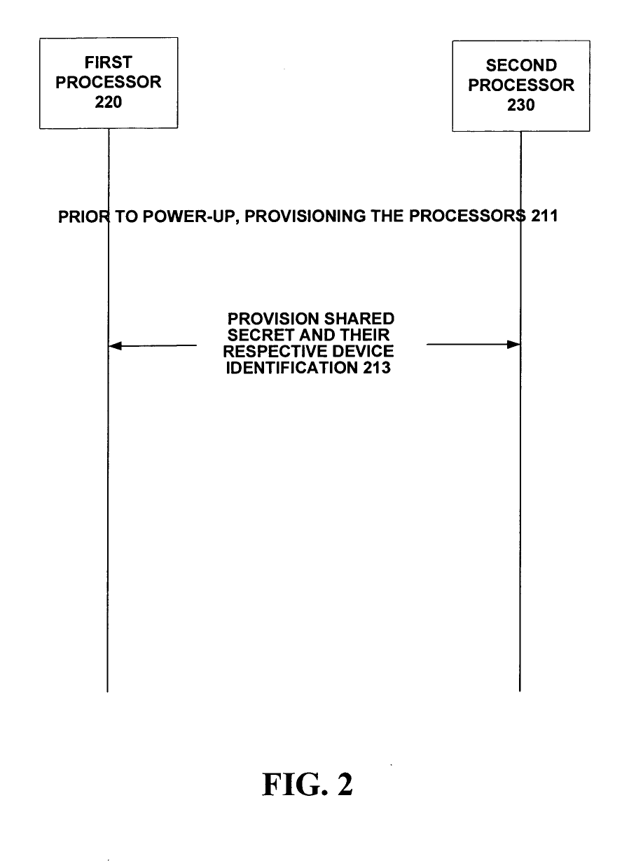

FIG. 2 illustrates a flow diagram of provisioning a first processor 220 and a second processor 230. Before the processors can engage in secure inter-processor communication link, the processors are provisioned 211 using steps 213 and 214. In some embodiments, the processors are provisioned at the factory before sale of a portable electronic device. In other embodiments, the processors can be provisioned at the point of sale. In step 213 the shared secret SS is set or stored in the processors. In step 214 the processors respective device identifiers are set or stored in both of the processors.

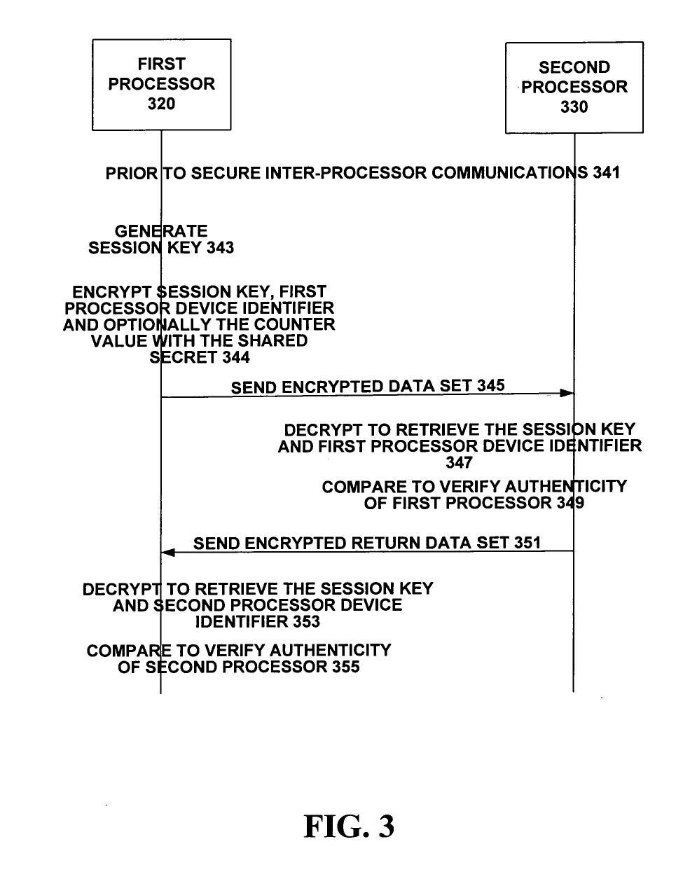

FIG. 3 illustrates a flow diagram of secure inter-processor communications by steps 341 through 355. A secure inter-processor communication link protocol is initiated 341 at power-up. A session key is generated at step 343 by the first processor 320. The session key, the first processor unique identifier, and optionally the counter value incremented by one, is encrypted using the shared secret 344 and sent as an encrypted session key data set to the second processor 330 at step 345. The second processor at step 347 decrypts the received session key data set to retrieve the session key, the first processor device identifier, and an optional counter value. The second processor 330, at step 349, then compares the first processor device identifier obtained from the decryption, against the expected first processor device identifier (stored by the second processor during provisioning) to verify authenticity of the first processor.

At step 351 a session key return data set is encrypted by the second processor using the session key 343 and sent to the first processor. The session key return data set contains the second processor device identifier and optionally the second processor's counter value incremented by one. At step 353 the first processor decrypts the received session key return data set to retrieve the session key and the second processor device identifier. Finally, at step 355 the first processor compares the received second processor device identifier obtained from the decryption against the expected second processor device identifier (stored by the first processor during provisioning) to verify authenticity of the second processor.

In accordance with embodiments of the present inventions, secure inter-processor communication between processors within a portable electronic device is achieved with particular messages and identifiers. In these embodiments, each processor has a device identifier that is unique and unalterable. Each processor also has a secret key that is not accessible by unauthorized processes. The first processor has a shared secret (SS) and the second processor has a shared secret (SS2). Each processor is provisioned with both shared secrets (SS and SS2), encrypted with their respective secret key. Each processor is provisioned with the other's unique identifier, encrypted with its respective secret key.

Then, to initiate establishment of a secure inter-processor communication link, a session key data set (M1) comprising the session key (SK) and a first processor device identifier is encrypted using a first shared secret (SS) at the first processor.

At the second processor, the session key data set (M1) is decrypted using the first shared secret (SS) to retrieve the session key (SK) and the first processor device identifier. Then at the second processor the decrypted first processor device identifier is compared against a known first processor device identifier to verify authenticity of the first processor.

Using a second shared secret (SS2), the second processor encrypts a session key return data set (M2) that comprises a second processor device identifier. Then using the second shared secret (SS2), the first processor decrypts the session key return data set (M2). In some alternative embodiments, the second processor encrypts a session key return data set (M2) that comprises a second processor device identifier using the session key (SK). Then using the session key (SK), the first processor decrypts the session key return data set (M2). Then at the first processor the decrypted second processor device identifier is compared against a known second processor device identifier to verify authenticity of the second processor.

In other alternative embodiments, encrypting a session key return data set comprises encrypting at the second processor, using the second shared secret (SS2), a session key return data set M2 that comprises a second processor device identifier and the session key (SK).

The first shared secret (SS) and the second shared secret (SS2) can be the same shared secret (SS) whereby the encrypting and decrypting for the first processor device identifier uses the same shared secret (SS) as the encrypting and decrypting for the second processor device identifier.

The session key (SK) is preferably generated by a pseudorandom generator algorithm.

The encryption and decryption by the processors are preferably performed by a symmetrical algorithm such as the Data Encryption Standard DES, Triple-DES, or the Advanced Encryption Standard AES. Even though a symmetrical algorithm is optimum, alternatively, encryption by public key or PKI can be used but is more processor intensive. The shared secret (SS) is securely stored in memory internal to each processor.

These embodiments of the inventions take advantage of both the unique unalterable identifier of the processors and the ability to keep a secret key in secure memory. This allows a key exchange to be performed using a symmetric key algorithm, which is quicker and more efficient than a public key algorithm. Thus the code size is less, the key size is less, and the performance is better.

At power-up or initiation of secure communications link protocol to establish the secure inter-processor communications, the first and second processors are initialized. Upon initialization of the first processor, a first processor counter value may be initialized and, upon initialization of the second processor, a second processor counter value may be initialized. The encryption may use such counter values for enhanced security. Encrypting the session key data set may then use the first shared secret (SS) to encrypt at the first processor the session key data set comprising the session key (SK), a first processor device identifier and the first processor counter value incremented by one. Comparing to verify authenticity of the processors comprises comparing the first processor counter value to the second processor counter value where the first processor counter value should be one greater than the second processor counter value. Encrypting a session key return data set may then use the second shared secret (SS) to encrypt at the second processor the session key return data set comprising the second processor device identifier and the second processor counter value incremented by one. Encrypting a session key return data set may use the second shared secret (SS) to encrypt at the second processor the session key return data set comprising the second processor device identifier, the second processor counter value and a session key. Comparing to verify authenticity of the second processor compares that the second processor counter value is the same as the first processor counter value.

At the factory before sale of a portable electronic device, the processors may be provisioned. Alternatively the processors may be provisioned at the point of sale. Provisioning is needed prior to initiation of secure inter-processor communications. Provisioning sets each processor with at least its shared secret SS and both of their respective device identifiers.

In some embodiments, a check is made prior to provisioning to determine whether or not the processors have already been provisioned, and if so, to not allow the re-provisioning of a processor. This is to prevent a hacker from replacing one of the processor's and attempting to subvert the other processor by forcing a provisioning of the hacker's processor. This can be accomplished by checking for a provisioning flag in permanent memory such as a One-Time-Programming (OTP) location, or merely looking for the presence of a shared secret (SS) securely stored in the processor.

Specifically, prior to establishing the secure inter-processor communication link, the following substeps can be performed to provision the processors: (a) generating a pseudorandom, shared secret (SS) by the first processor. The SS must remain secret (e.g., stored in secure memory or encrypted with the processor's secret key, not revealed to the outside bus, accessible by internal trusted software only). (b) encoding, such as by concatenating, at the first processor a provisioning data set (SS|UID1) that comprises a first processor device identifier (UID1) and the shared secret (SS); this encoding of the provisioning data set uses the shared secret (SS) to encrypt the first processor identifier (UID1), or alternatively the first processor identifier (UID1) may be sent as plaintext; (c) decoding at the second processor the provisioning data set (SS|UID1) to obtain at least the first processor device identifier (UID1) from the first processor and obtain the shared secret (SS), and storing in encrypted fashion the shared secret (SS) and first processor device identifier (UID1) using its secret key; (d) encoding in the second processor the second processor device identifier (UID2); this encoding of the provisioning data set uses the shared secret (SS) to encrypt the second processor identifier (UID2), or alternatively the second processor identifier may be sent as plaintext; and (e) decoding in the first processor the second processor device identifier (UID2) and storing the second processor identifier in encrypted fashion with its secret key. Alternatively to a) the generating of the shared secret (SS) may be done by a third source and the third source transmits SS to the first processor. The third source may transmit SS to the second processor or the first processor may transmit SS to the second processor.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure. For example, although radiotelephone examples are disclosed, the inventions are applicable to laptops and Personal Digital Assistants as well as pagers, MP3 players, game consoles and digital cameras or portable video recorders.

What is claimed is:

1. A method for secure inter-processor communications between processors within a portable electronic device, wherein each processor has a device identifier that is unique and unalterable, said method comprising the step of:
(a) generating at a first processor a session key;
(b) using a first shared secret, encrypting at the first processor a session key data set comprising the session key generated in said step (a) and a first processor device identifier;
(c) using the first shared secret, decrypting at a second processor the session key data set to retrieve the session key and the first processor device identifier;
(d) comparing at the second processor the decrypted first processor device identifier against a known first processor device identifier to verify authenticity of the first processor;
(e) using a second shared secret, encrypting at the second processor a session key return data set that comprises a second processor device identifier;
(f) using the second shared secret, decrypting at the first processor the session key return data set; and
(g) comparing at the first processor the decrypted second processor device identifier and a known second processor device identifier to verify authenticity of the second processor.

2. A method according to claim 1,
wherein the first shared secret and the second shared secret are the same shared secret; and
wherein the encrypting and decrypting of said steps (b) and (c) for the first processor device identifier uses the same shared secret as the encrypting and decrypting of said steps (e) and (f) for the second processor device identifier.

3. A method according to claim 1, wherein said step (a) of generating a session key at a first processor comprises the step of generating a pseudorandom session key.

4. A method according to claim 1, wherein the encrypting and decrypting of said steps (b), (c), (e) and (f) uses a symmetrical algorithm.

5. A method according to claim 1, wherein said step (e) of encrypting a session key return data set comprises using the second shared secret, encrypting at the second processor a session key return data set that comprises a second processor device identifier and the session key.

6. A method according to claim 1, further comprising the steps of:
(h) upon initialization of the first processor, initializing a first processor counter value; and
(i) upon initialization of the second processor, initializing a second processor counter value.

7. A method according to claim 6, wherein said step (b) of encrypting a session key data set comprises using the first shared secret to encrypt at the first processor the session key data set comprising the session key, a first processor device identifier, and the first processor counter value incremented by one.

8. A method according to claim 6, wherein said step (d) of comparing to verify authenticity of the first processor comprises the substep of (d)(1) comparing the first processor counter value and the second processor counter value where the first processor counter value is one greater than the second processor counter value.

9. A method according to claim 6, wherein said step (e) of encrypting a session key return data set comprises using the second shared secret to encrypt at the second processor the session key return data set comprising the second processor device identifier and the second processor counter value incremented by one.

10. A method according to claim 9, wherein said step (e) of encrypting a session key return data set comprises using the second shared secret to encrypt at the second processor the session key return data set comprising the second processor device identifier, the second processor counter value and the session key.

11. A method according to claim 6, wherein said step (g) of comparing to verify authenticity of the second processor comprises the substep of (g)(1) comparing the second processor counter value and the first processor counter value.

12. A method according to claim 1,
wherein the method further comprises the step of (h) provisioning the processors with at least the shared secret and their respective device identifiers; and
wherein said step (h) is performed prior to said steps (a)-(g).

13. A method according to claim 12,
wherein the method further comprises the step of (i) checking to make sure that the processors have not already been provisioned; and
wherein said step (i) is performed prior to said step (h).

14. A portable electronic device capable of secure inter-processor communications between processors within the device, comprising:
a first processor having a first processor device identifier that is unique and unalterable and for using a first shared secret to encrypt a session key data set comprising the session key and the first processor device identifier and for using the second shared secret to decrypt a session key return data set to obtain a decrypted second processor device identifier and for comparing the decrypted second processor device identifier and a known second processor device identifier to verify authenticity of the second processor; and
a second processor having a second processor device identifier that is unique and unalterable and for using the first shared secret to decrypt the session key data set to retrieve the session key and the first processor device identifier and comparing the decrypted first processor device identifier and a known first processor device identifier to verify authenticity of the first processor and for using the second shared secret to encrypt the session key return data set that comprises a second processor device identifier.

15. A portable electronic device according to claim 14, wherein the first shared secret and the second shared secret are the same shared secret.

16. A portable electronic device according to claim 14 wherein the first and second processors use a symmetrical algorithm to perform the encryption and decryption.

17. A portable electronic device according to claim 14, wherein the second processor encrypts the session key return data set comprising a second processor device identifier and the session key.

18. A portable electronic device according to claim 14, wherein the first and second processors are provisioned with at least the first and second shared secret and their respective device identifiers.

19. A portable electronic device according to claim 14, wherein each processor comprises internal memory for securely storing the shared secret.

20. A radiotelephone capable of secure inter-processor communications between processors within the radiotelephone, comprising:
a first processor having a first processor device identifier that is unique and unalterable and for using a first shared secret to encrypt a session key data set comprising the session key and the first processor device identifier and for using the second shared secret to decrypt a session key return data set to obtain a decrypted second processor device identifier and for comparing the decrypted second processor device identifier and a known second processor device identifier to verify authenticity of the second processor; and
a second processor having a second processor device identifier that is unique and unalterable and for using the first shared secret to decrypt the session key data set to retrieve the session key and the first processor device identifier and comparing the decrypted first processor device identifier and a known first processor device identifier to verify authenticity of the first processor and for using the second shared secret to encrypt the session key return data set that comprises a second processor device identifier.
